(19) United States
(12) Patent Application Publication
(10) Pub. No.: US 2006/0086857 A1
(43) Pub. Date: Apr. 27, 2006

(54) Bale processor with twine cutting assist on the rotor

(76) Inventors: Charles Lepage, Saskatoon (CA); Kimball Lischynski, Saskatoon (CA); Murray Kosokowsky, Pilger (CA)

Correspondence Address: Mr. Adrian D. Battison;Ade & Company, 1700-360 Main Street, Winnipeg, R3C 3Z3, CA

(21) Appl. No.: 11/120,952

(22) Filed: May 4, 2005

(30) Foreign Application Priority Data
Jun. 15, 2004 (CA) 2,472,569

(51) Int. Cl. B02C 1/08

(52) U.S. Cl. 241/277

(57) ABSTRACT

A bale processor is provided having a hopper converging inwardly and downwardly to a lower disintegration area at which is located a flail roller rotatable about an axis extending generally along the hopper and including a drive roller or rollers in the hopper for driving rotation of the bale around an axis parallel to the flail roller axis. The material is discharged through an opening in one side wall of the hopper. The flail roller is modified by providing a pair of diametrically spaced longitudinal single ribs which raise wrapped twine from the surface and allow an operator to reach in through the discharge opening and to cut away the twine at the raised section.

This invention relates to a bale processor which provides elements for use in cutting twine wrapped on the rotor.

### BACKGROUND OF THE INVENTION

U.S. Pat. No. 6,578,784 (Lischynski) issued Jun. 17, 2003 to HighLine Manufacturing Inc. discloses a well known type of bale processor in which there is provided a hopper with two end walls and two side walls converging inwardly and downwardly to a discharge area at the bottom of the side walls. One of the side walls has an opening at the discharge area to allow material to be discharged. Within the hopper is provided one or more driven rollers which act to rotate the bale around its axis arranged longitudinally of the hopper. At the bottom of the hopper is provided a flail roller which rotates around an axis longitudinally of the hopper and carries a priority of flails for engaging and removing the baled crop material to be discharged through the discharge opening.

This construction is well known and many different parts show the details of this arrangement including a number of patents issued to HighLine.

One problem which arises in arrangements of this type is that the bale twine which remains on the bale during the processing action is ripped away from the bale and is wrapped around the flail roller. Eventually enough twine collects on the flail roller so that it interferes with the operation caused by engaging the flails and preventing their proper action.

A number of attempts have therefore been made to provide devices which assist in removing the wrapped twine so as to avoid the necessity for the operator to hack at the wrapped twine unaided by the construction of the device.

Canadian Patent 2,202,014 (Kjenner) issued Mar. 20, 2001 discloses a knife blade which runs with a channel attached to the outside surface of the roller. The channel guides the sliding action of the knife blade along the roller and the knife blade is pulled by a cable on one side as it slides along the channel.

The above patent of Lischynski and another U.S. Pat. No. 6,711,824 (Hruska) issued Mar. 30, 2004 to Bridgeview Manufacturing Inc. both disclose an arrangement in which a knife blade is operated from one end wall of the hopper by a push rod which the operator slides through the end wall thus driving a knife blade along a channel defined on the outside surface of the roller. The channel is formed by a pair of raised ribs this forming a narrow slot there between guiding the movement of the knife.

All of these arrangements operates satisfactorily but are disadvantages in that they are relatively complex and expensive. Complexity leads to potential breakdown. Expensiveness leads to a significant increase in the cost of the machine thus reducing its attractiveness to potential purchasers.

### SUMMARY OF THE INVENTION

It is one object of the invention to provide an improved bale processor which provides elements for use in cutting wrapped twine but which are of a simple economic construction so as to reduce costs.

According to one aspect of the invention there is provided a bale processor comprising:
a hopper for receiving a bale to be processed having two side walls and two end walls arranged to define an open top through which the bale is loaded;
the two side walls converging inwardly and downwardly to a lower disintegration area;
a flail roller mounted in the disintegration area and rotatable about an axis extending generally along the side walls and transverse to the end walls;
at least one drive member in the hopper for driving rotation of the bale around an axis generally parallel to the flail roller axis;
the flail roller providing a cylindrical surface having a plurality of flails mounted thereon for movement therewith around the flail roller axis for engaging the bale and removing material therefrom;
one of the side walls having a discharge opening at the disintegration area for discharge of the material removed from the bale by the flail roller from the disintegration area;
the cylindrical surface of the roller having a plurality of longitudinally extending raised ribs thereon for providing a recess between a side edge of the rib and the surface of the roller within which twine wrapped around the surface can be cut by a knife;
the ribs being arranged at angularly spaced positions so as to provide balance of the weight of the ribs around the axis of the roller;
each of the plurality of ribs being spaced on each side thereof from the next rib of the plurality of ribs by a wide angular extent of the surface sufficient that the twine on each side of the rib extends from the rib to the surface before reaching the next rib.

Preferably there are only two ribs spaced diametrically of the roller, although there may be more such as two or three provided they are widely spaced and balanced around the axis.

Preferably the ribs are spaced each from the next at the same angular spacing which provides the necessary balance.

Preferably the ribs are parallel to the axis although they may be helical or inclined to the axis.

Preferably the ribs are shaped so as to define two side edges each extending generally at right angles to the surface although a raised side edge may be provided only on one side.

### BRIEF DESCRIPTION OF THE DRAWINGS

One embodiment of the invention will now be described in conjunction with the accompanying drawings in which:

FIG. 1 is an isometric view of a bale process according to present invention.

FIG. 2 is a side elevational view of the rotor of FIG. 1 on an enlarged scale showing one of the ribs.

FIG. 2 is a cross sectional view of the rotor of FIG. 1 on an enlarged scale showing the diametrically opposed ribs.

In the drawings like characters of reference indicate corresponding parts in the different figures.

### DETAILED DESCRIPTION

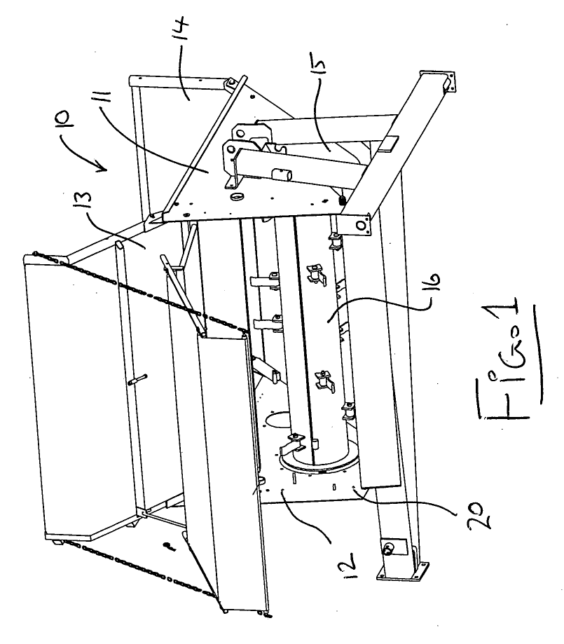

A conventional bale processor as shown in FIG. 1 includes a hopper 10 designed by end walls 11 and 12 together with side walls 13 and 14. The side walls converge inwardly and downwardly to a disintegration area 15 at the bottom of the hopper within which is located a flail roller or rotor 16. The rotor forms a cylindrical wall having a smooth cylindrical outer surface as indicated at 17 and carries a plurality of flails 18 which are mounted on pivotal supports 19 attached to the outer surface of the cylindrical wall 17. The rotor is mounted on suitable bearings so as to be carried within the hopper extending longitudinally of the hopper with an axis A of the rotor extending along the length of the hopper from one end wall to the other end wall. The side wall 13 includes a discharge opening 20 in the area of the flail roller so that material grasped by the flails of the flail roller is rotated around underneath the flail roller and discharged through the discharge opening. The discharge opening thus forms a slot across the width of the wall 13 in the disintegration area. A drive assembly is mounted within the hopper and is formed by one or more drive rollers which are arranged in the hopper parallel to the axis of the rotor so the bale sits on the drive roller or drive rollers and upon a grate (not shown) over the flail roller so that the bale is rotated within the hopper while the flail acts to remove the material form the bottom of the bale.

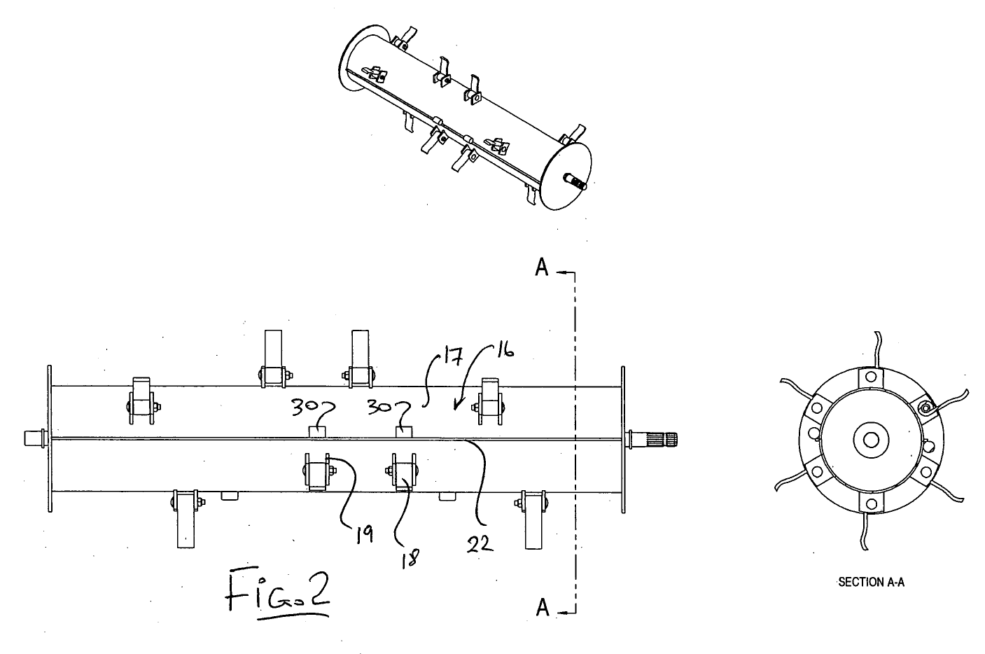

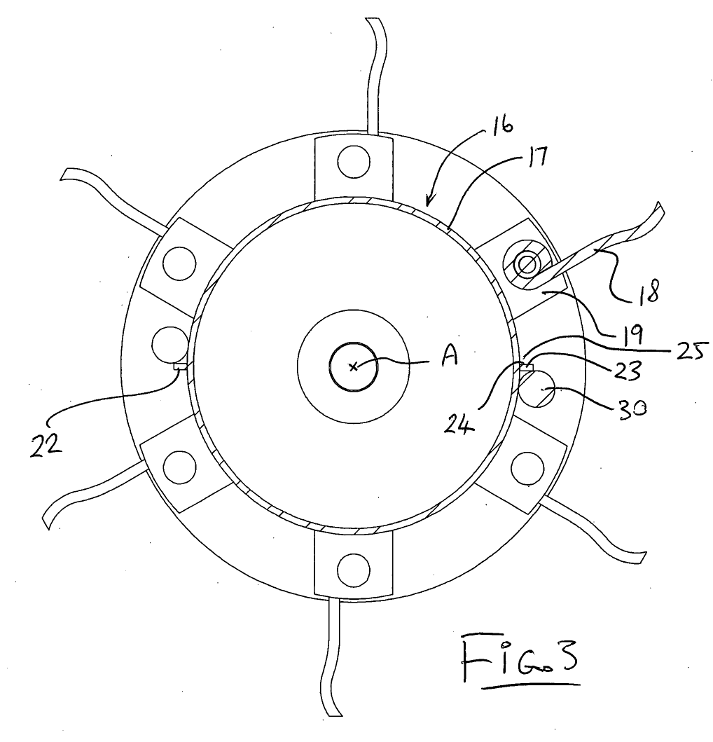

As shown in FIG. 2, the outer surface of the roller defined by the wall 17 is supplemented by a pair of bars 22 and 23 which are diametrically opposed relative to the axis A. Thus the bars are spaced so that they are balanced around the axis to prevent unbalancing rotation of the rotor. Each rib is formed by a single rib or bar with side walls of the rib or bar extending at right angles to the surface of the roller at the position of the rib or bar. This defines a V-shaped area 25 between the side wall 24 of the rib and the surface 17. Thus twine wrapped around the rotor is raised at the rib so that it is lifted away from the surface 17 to leave a recess at which the twine can be cut. The ribs are relatively widely spaced by 180 degrees in the embodiment shown. The wide spacing is sufficient that the twine when it leaves the side edge 23 extends therefrom to the surface rather than to the next rib.

Thus in effect the minimum number of bars is used which is a pair of such bars arranged diametrically so as to provide the necessary balancing effect while maintaining a minimum cost for materials and for attachments of the bars to the outer surface by welding. Additional bars can be provided at other spacing but not such that the bars are sufficiently closely located that the twine extends between the bars without contacting the surface.

The bars are arranged to have a height which is sufficient merely to define the recess between the wrapped twine and the surface 17 so that the operator can apply a knife along the side edge 23 and a cutting action to cut the twine with a knife projecting through the twine into the recess 23.

Thus the arrangement provides the minimum necessary assisting elements to allow the operator to effectively cut the twine away from the rotor by reaching through the discharge opening.

This arrangement provides a minimum cost device of a simply nature which avoids any problems of breakdown or damage since the equipment is sufficient simply and rugged.

Known back slap members 30 are provided on the surface 17 for those flails 18 which would otherwise impact on the rib so as to prevent damage to the rib or to the outer surface 17. The back slap members 30 are provided in the form of a short cylindrical member which extends only over the width of the flail and has a diameter greater than the height of the rib so as to ensure that the flail when bouncing back engages the cylindrical back slap member rather than the rib. The back slap members are located directly adjacent the rib on one side thereof but do not interfere with the cutting action which takes place on the opposite side.

Since various modifications can be made in my invention as herein above described, and many apparently widely different embodiments of same made within the spirit and scope of the claims without department from such spirit and scope, it is intended that all matter contained in the accompanying specification shall be interpreted as illustrative only and not in a limiting sense.

1. A bale processor comprising:
a hopper for receiving a bale to be processed having two side walls and two end walls arranged to define an open top through which the bale is loaded;
the two side walls converging inwardly and downwardly to a lower disintegration area;
a flail roller mounted in the disintegration area and rotatable about an axis extending generally along the side walls and transverse to the end walls;
at least one drive member in the hopper for driving rotation of the bale around an axis generally parallel to the flail roller axis;
the flail roller providing a cylindrical surface having a plurality of flails mounted thereon for movement therewith around the flail roller axis for engaging the bale and removing material therefrom;
one of the side walls having a discharge opening at the disintegration area for discharge of the material removed from the bale by the flail roller from the disintegration area;
the cylindrical surface of the roller having a plurality of longitudinally extending raised ribs thereon for providing a recess between a side edge of the rib and the surface of the roller within which twine wrapped around the surface can be cut be a knife;
the ribs being arranged at angularly spaced positions so as to provide balance of the weight of the ribs around the axis of the roller;
each of the plurality of ribs being spaced on each side thereof from the next rib of the plurality of ribs by a wide angular extent of the surface sufficient that the twine on each side of the rib extends from the rib to the surface before reaching the next rib.

2. The bale processor according to claim 1 wherein there are only two ribs spaced diametrically of the roller.

3. The bale processor according to claim 1 wherein the ribs are spaced each from the next at the same angular spacing.

4. The bale processor according to claim 1 wherein the ribs are parallel to the axis.

5. The bale processor according to claim 1 wherein the ribs are shaped so as to define two side edges each extending generally at right angles to the surface.
